(19) United States
(12) Patent Application Publication
(10) Pub. No.: US 2026/0037925 A1
(43) Pub. Date: Feb. 5, 2026

(54) SYSTEM AND METHOD FOR IDENTIFYING JOB CANDIDATES AND EMPLOYEE CHAMPIONS TO MAKE AND MAINTAIN EMPLOYMENT REFERRAL, AND FOR PROVIDING ONGOING EMPLOYMENT TRACKING OF REFERRED CANDIDATE, AND ONGOING REFERRAL PAYMENTS TO REFERRING EMPLOYEE

(71) Applicant: It’s Jobvious, Inc., Columbus, OH (US)

(72) Inventors: Brad Beach, Columbus, OH (US); Danny Hollis, Columbus, OH (US)

(21) Appl. No.: 19/271,298

(22) Filed: Jul. 16, 2025

Related U.S. Application Data
(60) Provisional application No. 63/671,901, filed on Jul. 16, 2024.

(51) Int. Cl. G06Q 10/1053; G06Q 30/0214

(52) U.S. Cl. CPC G06Q 10/1053; G06Q 30/0214

(57) ABSTRACT

A system and method for making and evaluating job candidate referrals is described. The system and method includes streamlined, software-based hiring by way of recommendations and referrals, such as from current employees, who are incentivized by revenue sharing to those current employees making the referrals. In one example of the system of the present invention, a software application for parsing and matching job candidates to prospective positions is provided. The software application is capable of automatically identify a champion (current employee connected to the candidate) to provide the referral, and calculating a reward for, and disbursing corresponding payment to, the individual (e.g., champion) who made the referral. The software application tracks ongoing employment and continues to disburse corresponding payment to the referring individual (e.g., champion) during the course of employment of the referred individual and referring individual.

### CROSS-REFERENCE TO RELATED APPLICATIONS

This non-provisional patent application claims priority to U.S. Provisional Application No. 63/671,901 filed on Jul. 16, 2024, which is hereby incorporated by reference in its entirety as if fully recited herein.

### TECHNICAL FIELD

Embodiments of the present disclosure relate generally to a system and method for making and evaluating job candidate referrals. More particularly, the system and method provides streamlined, software-based hiring by way of recommendations and referrals from current employees who are incentivized by revenue sharing to those current employees making the referrals. In one example, without limitation, a software application for parsing and matching job candidates to prospective positions is provided, wherein the software application is configured to automatically identify a champion (e.g., current employee connected to the candidate) to provide the referral, and/or wherein the software application is configured to automatically calculate a reward for, and disburse corresponding payment to, the individual (e.g., champion) who made the referral of the candidate who is hired. In exemplary embodiments, without limitation, the software application tracks ongoing employment and continues to disburse corresponding payment to the referring individual (e.g., champion) during the course of employment of the referred individual, and in exemplary embodiments also the referring individual (e.g., during continued employment of both).

### BACKGROUND AND SUMMARY OF THE INVENTION

Traditionally, companies find candidates for a job opening through job postings and recruiters. An issue with job postings is that many candidates who are not qualified or a good fit for a particular job may apply. An issue with recruiter-based hiring is that recruiters generally only have influence in having an individual hired, but generally lack ongoing influence to keep the referred individual employed at the employer after they are hired. A significant amount of searching, vetting, and time-consuming credential review is also required with traditional hiring techniques. This is particularly, but not exclusively, true with certain positions, such as relatively lower wage, hourly pay positions, where relatively high levels of turnover are common.

The aforementioned shortcomings speak to the need for a streamlined, software-based hiring system that promotes hiring by way of referrals from other individuals (e.g., current employees) who are incentivized to make the referrals, and to get the referred individual hired, and to keep the referred individual employed at the hiring entity, particularly as the referring individual generally has day-to-day influence over the referred individual, thereby providing means and opportunity to encourage the referred individual to maintain employment at their position.

In view of this, it is beneficial to have a system and method for worker employer referral as described herein. Particularly, to provide the incentive for referring individuals to take advance of the means and opportunity to encourage maintenance of employment. However, it is difficult and technologically challenging to track such referrals, ongoing employment, and referral payments, particularly for a large number of employees across a large number of entities. In particular, typically, such employment is normally tracked in various, otherwise disparate systems in various, otherwise incompatible formats. These disclosures provide technical solutions to these, and other, problems that are specific to this field.

According to the present invention in one aspect, a software application for worker employer referral may include, e.g., a candidate referral module, a candidate evaluation module, and a reward distribution module. The candidate referral module may permit an individual (e.g., employee of a company) to refer a candidate to the company for one or more job openings. In exemplary embodiments, the software application includes a social media platform or module for creating users/user profiles (e.g., job seekers, job holders, employers, and the like). The candidate referral module may be configured to identify candidate employees (e.g., of job seekers from profile/user information) for open positions (e.g., from job postings created by job holder users). The candidate referral module may be further configured to identify connected users (e.g., job holders, from profile/user information) to the candidate to make a referral to the open position to the individual. This identified referral individual may sometimes be referred to herein as a “champion”.

The candidate evaluation module may be configured to automatically verify that the candidate is qualified for a particular job opening by, for example, comparing extracted data from the candidate's resume to job requirement thresholds, and may permit decision makers at the company to evaluate the candidate's credentials. In other exemplary embodiments, without limitation, the candidate evaluation module may identify individuals for an open position and the candidate referral module may identify individuals to make the referral to the identified individual, such as based on previously stored connection information between the individuals.

The candidate evaluation module may include a matching algorithm for identifying candidates for open positions, and optionally associated champions for making the referrals. If the candidate is hired, the software application may register that the candidate is now an employee of the company. For as long as both the new employee and the employee who made the referral are employed at the company (or in other embodiments, so long as the referred individual remains employed at the company), the software application may automatically calculate an amount of reward money to distribute to the individual (e.g., employee) who made the referral and may optionally be configured to automatically cause such payment to be disbursed to an account affiliated with the referring individual. The reward money may be a percentage of the referred individual's employment income (e.g., a percentage of the referred employee's hourly pay) distributed over time increments, though other calculations may be utilized (e.g., flat fee, amount per time increment worked, combinations thereof, or the like). While sometimes discussed as a referral employee, the application may include automated payment and calculation to other referral sources, such as an affiliated recruiter, HR member, manager, or party otherwise employed by or affiliated with the hiring entity.

A plurality of workflows may be implemented by an exemplary system to match job applicants to certain job opportunities, and distribute fees to system users. A system workflow may assist job applicants in preparing a resume for submission to an exemplary system for matching assessment. A system workflow may include a primary and secondary matching service for matching applicants to job opportunities. A system workflow may allow users to refer candidates to certain jobs based on the matching assessment. An exemplary system may distribute fees to a system user who have referred a candidate that has been hired and retained by an employer system user.

An exemplary system for facilitating worker employer referral matching and ongoing referral payments comprises one or more servers. For example, the servers may be in electronic communication with user devices, and may host a backend software application and user facing social media platform. The one or more servers may comprise at least one database comprising identity data and resume information for individuals, job criteria associated with job identifiers, and electronic associations between users from the user facing social media platform. The one or more servers may further comprise software instructions that, when executed, configure one or more processors to electronically and automatically receive data from a first subset of the user devices indicating the identity data and resume information for job candidates.

The software instructions may also, when executed, configure the one or more processors to extract, from the received data from the first subset of the user devices, the resume information and the identifying data for the job candidates for storage at the one or more databases. The software instructions may additionally, when executed, configure the one or more processors to receive, from a second subset of the user devices, job descriptions, and extract, from the received data from the second subset of the user devices, the job descriptions for storage at the one or more databases, each with a respective, assigned one of the job identifiers. Furthermore, the software instructions may, when executed, configure the one or more processors to compare the resume information for the job candidates to the job descriptions, determine match scores for the job candidates based on the comparison, and for each of the job descriptions, determine a highest scored one of the matched job candidates where the match score is also above a predetermined threshold (“matched candidate”).

In addition, the software instructions may, when executed, configure the one or more processors to display information regarding the matched candidate at an electronic display screen of a respective one of the user devices associated with a referring individual, and receive confirmation of employment for the matched candidate, and subsequently and in response, calculate a fee for the referring individual and cause electronic disbursement of the fee to an account provided at, and retrieved from, the database in association with the identifying information for the referring individual.

The one or more servers may further comprise software instructions that, when executed, configure the one or more processors to for each of the matched candidates, identify one of the users (champions) indicated, based on the resume information associated with the user at the database, as being employed at a respective hiring company for a respective one of the job descriptions and indicated as electronically associated with the matched candidate at the database from the social media platform. The software instructions may subsequently cause a notification to be sent to a respective one of the first subset of user devices associated with the champion indicating that the job candidate is identified for an open position. The software instructions, when executed, may cause the one or more processors to generate, at the user device associated with the champion, a customizable, template referral invitation for sending to the matched candidate, and in response to champion customization or approval of the template referral invitation, cause the referral invitation to be sent to the user device associated with the matched candidate. The software instructions may also cause information about the matched candidate to be communicated to a respective one of the second subset of the user devices associated with the job description.

One advantage of an exemplary embodiment is that employees of a company are incentivized to refer high quality candidates by the prospect of receiving ongoing, passive income for the duration that a referred employee is employed. Since the individual who made the referral receives passive income for the duration of the referred employee's employment, the individual who made the referral has a strong incentive to make sure the referred employee continues to work for the employer (e.g., does not become unhappy and quit, or be fired for poor performance). Unlike a traditional arrangement, in the exemplary embodiment, the referring employee may have ongoing, sometimes informal and outside of the employer/employee or fellow employee relationship, influence over the referred employee's activities, environment, attitude, and the like. Encouraging employees to keep their referrals happy and performing well may be particularly useful in the contingent labor market (e.g., warehouses) and/or for temporary jobs where turnover is often high. Another advantage is that employees of a particular company may be best suited to find quality candidates for an opening, and are more encouraged to seek out quality candidates if there is an ongoing financial reward for a referred candidate being hired and continuing to be employed.

### BRIEF DESCRIPTION OF THE DRAWINGS

Novel features and advantages of the present invention, in addition to those expressly mentioned herein, will become apparent to those skilled in the art from a reading of the following detailed description in conjunction with the accompanying drawings. The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates exemplary logic for candidate resume parsing, matching and usage;

FIG. 2 illustrates further exemplary logic for candidate resume parsing, matching and usage in accordance with the FIG. 1 embodiment;

FIG. 3 illustrates yet further exemplary logic for candidate resume parsing, matching and usage in accordance with the FIG. 1 embodiment;

FIG. 4 illustrates exemplary logic for an exemplary system for worker employer referral;

FIG. 5 illustrates further exemplary logic for the exemplary system of FIG. 4;

FIG. 6 illustrates yet further exemplary logic for the exemplary system of FIG. 4;

FIG. 7 illustrates yet further exemplary logic for the exemplary system of FIG. 4;

FIG. 8 illustrates exemplary logic for an exemplary method for worker employer referral;

FIG. 9 illustrates a schematic overview of the system;

FIG. 10 illustrates exemplary logic for a first preferred workflow for resume generation of the systems and/or methods of FIGS. 1-9;

FIG. 11 illustrates exemplary logic for a second preferred workflow for referral candidate matching of the systems and/or methods of FIGS. 1-9;

FIG. 12 illustrates exemplary logic for a third preferred workflow for candidate assessment of the systems and/or methods of FIGS. 1-9; and

FIG. 13 illustrates exemplary logic for an exemplary matching, referral and fee distribution system of the systems and/or methods of FIGS. 1-12.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

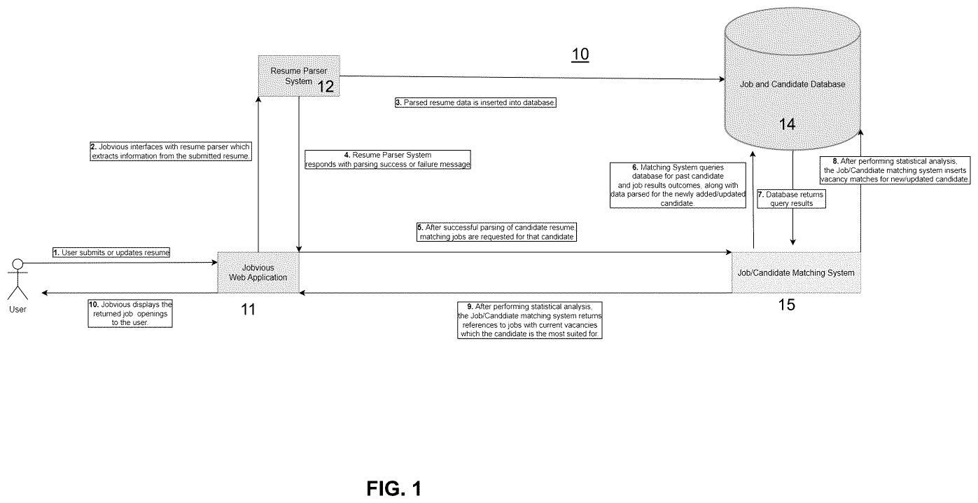

Referring now to FIGS. 1-3, exemplary logic for a preferred system 10 for worker employer referral is shown. The system 10 may include a software application (e.g., web application 11) for parsing and matching referred candidates to a prospective employer. The software may streamline employee referral, evaluation, and referral incentive reward distribution (e.g., revenue sharing) by automating aspects of initial candidate review (e.g., automatically parsing data from resumes), credential verification (e.g., automatically verifying that parsed data matches credential thresholds specified to the software application), and distribution of rewards to the individual who referred a candidate who is hired (e.g., automatically calculating a percentage of the referred employee's earnings to distribute to the individual who made the referral). The system may be especially beneficial for temporary jobs, because, for example, it encourages employees to keep their referred colleagues employed.

The system may optionally be configured to automatically disburse (or cause disbursement of) such payment to an account affiliated with the referral employee, such as by way of electronic and automated funds transfer, cryptocurrency payment, gift card purchase, check issuance, combinations thereof, or the like. These may be made directly by the application 11, or by way of communication with outside financial institutions (e.g., banks, electronic banking systems), which may form part of the system 10.

While a percentage is sometimes discussed, the payment may be other amounts such as a flat fee, amount per time increment employed or worked (e.g., X dollars per hour, day, week, etc.), combinations thereof, or the like.

While sometimes discussed as a referral employee, the application may include automated payment and calculation to other referral sources, such as an affiliated recruiter, HR member, manager, or party otherwise employed by or affiliated with the hiring entity.

A credential review module may permit a user (e.g., a current employee of a company) to upload the resume of an employee candidate that the user is referring to the company. Alternatively, or additionally, the credential review module may be configured to accept a referral link, code, token, or the like representing a referring user (e.g., current employee of company). The referral link, code, token, or the like may be generated by a referral module of the system 10.

The credential review module may be in communication with a resume parser module 12. The resume parser module 12 may be configured to parse the resume to extract important data, including, for example, the candidate's previous experience, education, skills, some combination thereof, or the like. The resume and data extracted from the resume may be communicated by the system 10 to a database 14 to be stored for later use. A user may be notified by the system 10 if resume parsing and storage of relevant data is successful, or if there are issues that need addressed. Such parsing and extraction may be accomplished by way of one or more optical character recognition techniques, which may utilize one or more large language models (“LLMs”), by way of non-limiting example. The LLMs, in exemplary embodiments, may be configured or trained on resumes, such as to identify particular headers or items affiliated with, for example without limitation, the candidate's previous experience, education, skills, some combination thereof, or the like.

In exemplary embodiments, the system 10, and more specifically the software application 11, includes a social media module or platform, such as for creating users/user profiles (e.g., job seekers, job holders, employers, and the like) based on uploaded information, including but not necessarily limited to, the resume information. For example, without limitation, the resume parser module 12 may be configured to automatically generate a user/profile or update an existing user/profile based on uploaded and analyzed resume information. Alternatively or additionally, the resume parser module 12 may be configured to generate a resume based on existing user/profile information. The social media module or platform may be configured to allow users to make electronic associations between one another, such as by way of known techniques, such as but not limited to, based on friendships, acquaintances, professional colleagues, professional contacts, classmates, combinations thereof, or the like. Such user/profile information and electronic associations may be stored at one or more databases forming part of the system 10.

The system 10 may be configured to determine appropriate potential job opportunities for candidates based on stored user/profile information, e.g., data extracted from the candidate's resume. For example, the system 10 may include a matching system module 15 configured to query the database 14 for information about potential job opportunities consistent with the candidate's credentials, and return query results to a user interface. The query results may include vacancy matches (e.g., when the extracted data matches the requirements for a vacant position, the position may be considered a vacancy match). Vacancy matches may be stored to the database 14. The user interface may be displayed on an electronic display of a computing device, including, for example, a smart phone, tablet, PC, some combination thereof, or the like.

The matching system module 15 may be configured to provide the results directly to the candidates. In other exemplary embodiments, however, the matching system module 15 may be configured to identify one or more associated individuals to the candidate (e.g., based on the electronic associations made by way of the social media platform or module) currently employed at the hiring company and return the results to these champions to make the referral to the candidate. This unconventional approach may increase the likelihood of acceptance and ongoing employment by the candidates. Notably, such association information may not otherwise be known or knowable by employers, recruiters, or the like. In this way, the system 10 provides a technological solution as to how to identify such champions to make and maintain referrals in an automated, electronic fashion.

The matching system module 15 may be configured to evaluate the likelihood of a positive outcome (e.g., probability for hiring of a qualified, quality candidate), and return matches where the likelihood of a positive outcome is the highest. The matching system module 15, and/or any other component of exemplary system software, may utilize machine learning and/or artificial intelligence. Machine learning may utilize Bayesian statistics to improve candidate to job matching over time. Machine learning may incorporate previous outcomes and stored parsed data. As a specific, non-limiting example, the system 10 may determine that a client user of the system software 11 is more likely to higher candidates with experience at a rival company, and thus the matching system module 15 may be more likely to match candidates with experience at the rival company to that particular client. Associations may be chained together with exemplary machine learning. With respect to the aforementioned example, the system 10 may consider that the client has only hired candidates with experience at the rival company who were at the rival company for at least a particular number of years, possessed a certain degree in particular field, some combination thereof, or the like. These factors may, optionally, be amalgamated into a score, which is used for comparative purposes. For example, without limitation, only candidates at least having a sufficient, predetermined threshold score may be considered, and of those candidates, they may be contacted in the order of their score (e.g., highest to lowest that is still above the threshold).

The system 10 may further be configured to evaluate the behavior of users in its analysis, and factor that behavior into job matching. As a specific, non-limiting example, where a client user company did not utilize previous recommendations, the system 10 may be less likely to make similar recommendations in the future.

Such machine learning/AI models may include a feedback training loop based on, for example without limitation, provided feedback regarding job placement (e.g., candidate hired or not), length of employment, pre- or post-employment survey data, combinations thereof, or the like. Such feedback may be used to train and improve the model over time.

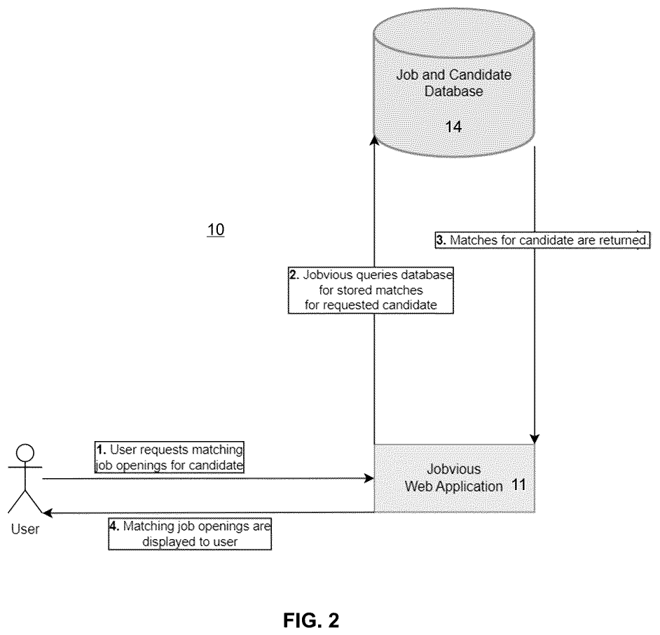

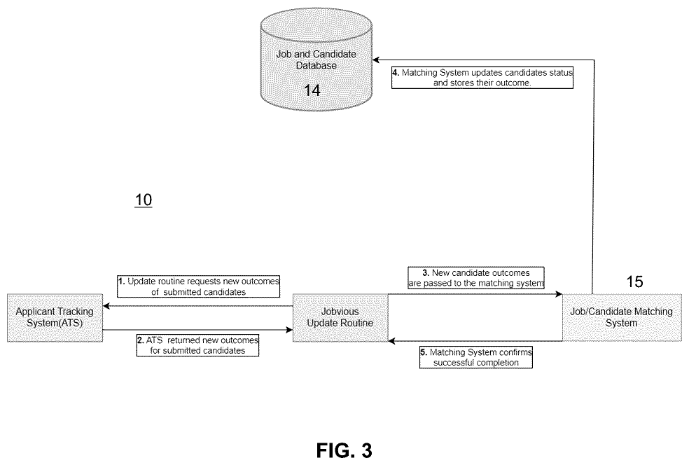

Referring specifically to FIG. 2, query results may be communicated to the user based on a user matching request. A user match request may involve a user uploading a resume. Match results may also be communicated to a client employer user after a new job opening is posted. System administrators may periodically upload job opportunities and related credential information to the database 14. Referring specifically to FIG. 3, the system 10 may permit users to update candidate information, information about desired outcomes for the candidate, some combination thereof, or the like as necessary. This information may be communicated to the matching system module 15, and factor into vacancy match determination. The system 10 may include an applicant tracking system module for storing information about new job openings and their descriptions. This information may include job requirements such as required education, required experience, required skills, some combination thereof, or the like. This information may be communicated to the matching system module. Information about how the candidate has performed in previous jobs, duration of employment in previous jobs, some combination thereof, or the like may also be evaluated by the matching system module 15, and factor into vacancy match determination. The creation of job openings, new users/user profiles, new user connections, combinations thereof, or the like, may trigger automatic and electronic reevaluation by the system 10 between candidates and openings for potential referral.

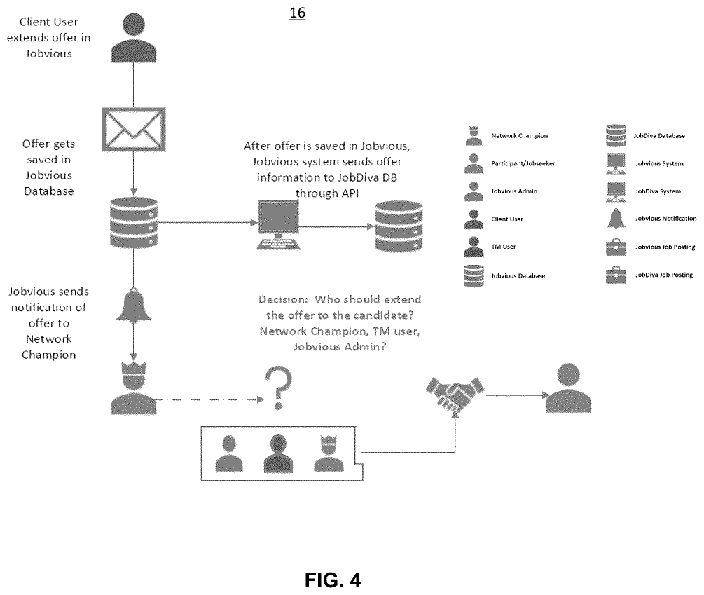

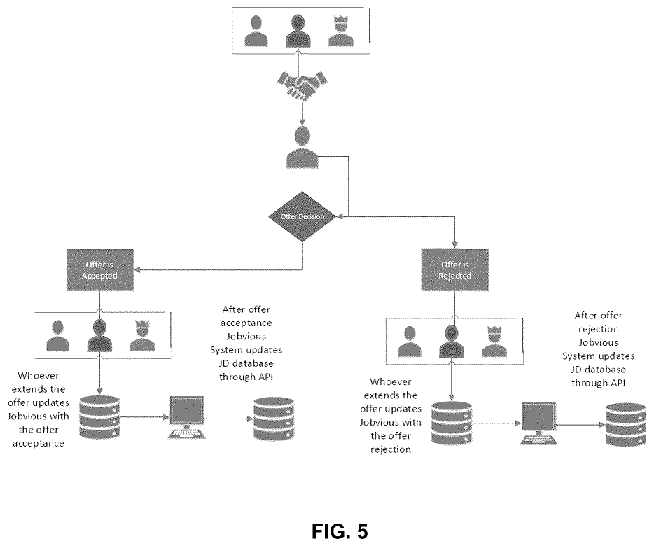

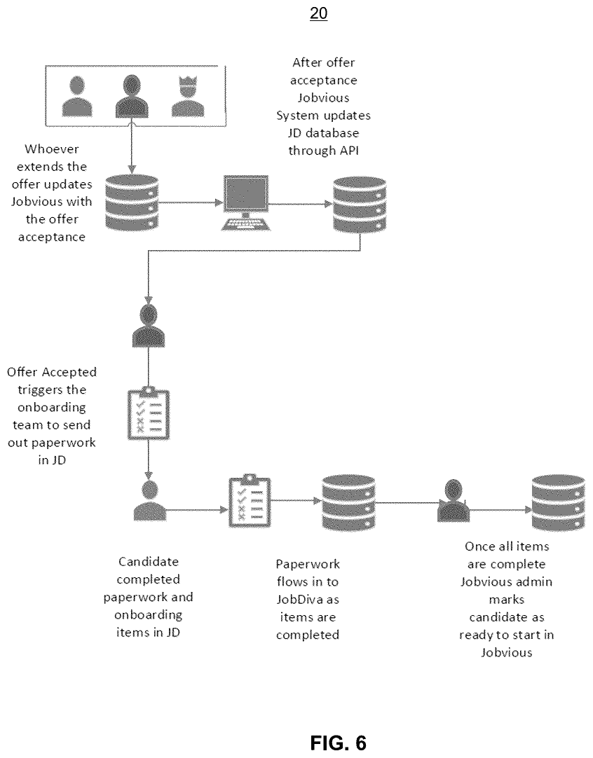

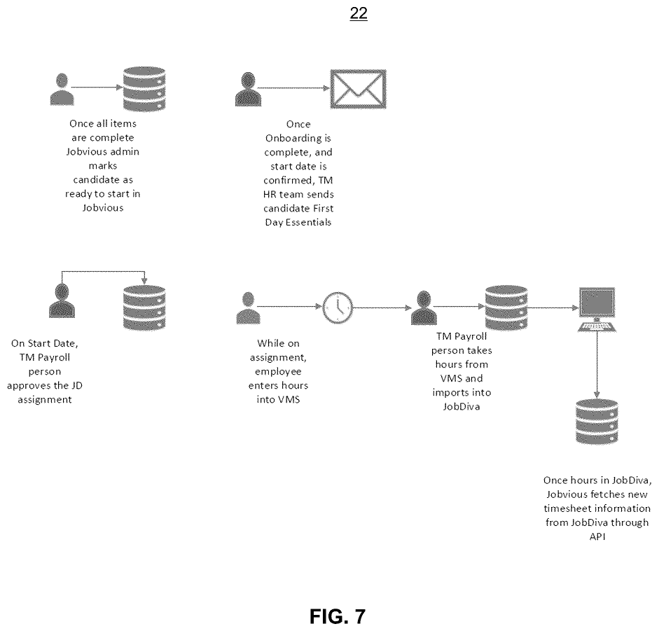

Referring to FIGS. 4-7, exemplary workflow logic 16, 18, 20, 22 for an exemplary system for worker employer referral is shown. FIG. 4 illustrates exemplary logic 16 for where a job offer is extended and saved to a database and electronic system updates made with regard the same. FIG. 5 illustrates exemplary logic 18 for where an offer is either accepted or rejected and electronic system updates made with regard the same. FIG. 6 illustrates exemplary logic 20 for where a job offer is accepted, and onboarding occurs and electronic system updates made with regard the same. FIG. 7 illustrates exemplary logic 22 for workflow related to payment distributions and electronic system updates made with regard the same.

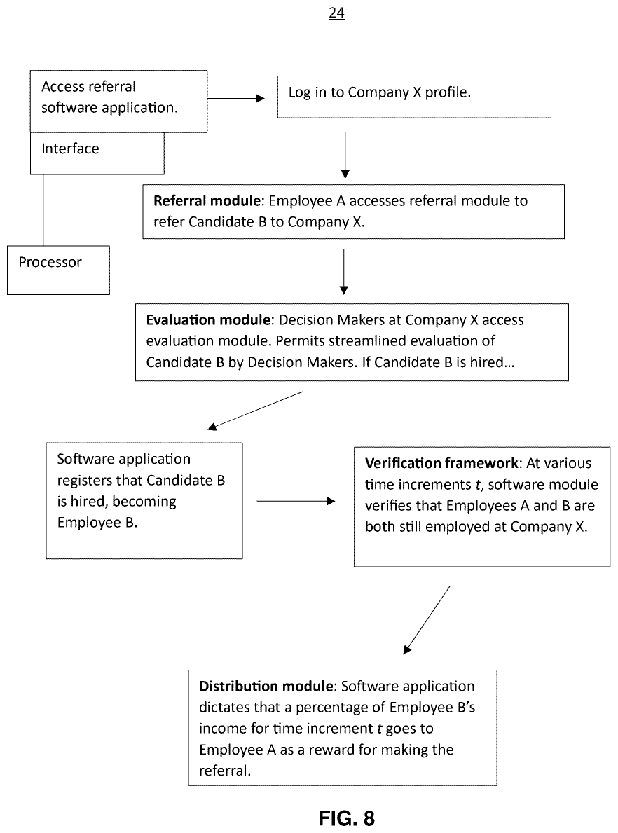

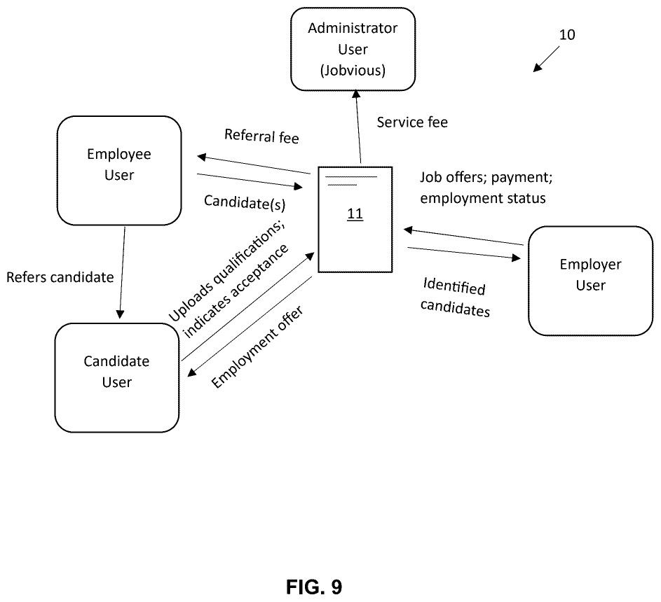

Referring to FIG. 8 and FIG. 9, an exemplary method 24 for worker employer referral includes providing a processor configured to execute instructions of a software application for worker employer referral. The processor may be in communication with an interface capable of displaying software application features and information. An employee of a company may log into the software application by way of the interface using a log in page. A referral module may permit the employee to refer an associated candidate (e.g., by way of social media connection) to the company for one or more job openings. Preferably, the referral module is configured to automatically generate a template referral message for the individual to send to the associated candidate, which may be personalized by the referring individual. An evaluation module may verify that the candidate is qualified for a particular job opening, and permit decision makers at the company to evaluate the candidate's credentials. The evaluation module may include a matching algorithm that identifies candidates for a position, notifies the referring employee when a candidate in their network matches to a position and invites the referring employee to refer the candidate to the position. If the candidate is hired, the software application may register that the candidate is now an employee of the company. For as long as both the new employee is employed at the company, the software application may automatically calculate an amount of reward money to distribute to the employee who made the referral. These features may be as shown and/or described in more detail herein.

The calculation amount (e.g., percentage, amount, flat fee, etc.) may be predetermined by the system, such as on an employer specific basis. For example, each affiliated employer may have a predetermined arrangement for rewards, which may be provided to the referring user prior to referral, such as but not limited to, with sign up of the application, at the point of generating a referral link, code (e.g., alphanumeric and/or optically readable), token, combinations thereof, or the like. Such amounts or formulae may be stored at the application 11 and/or affiliated database 14, by way of non-limiting example. The calculation amount may include a fee or other distribution made to an entity affiliated with the application 11, such as a service fee or commission by way of example.

The system 10 may be configured to automatically disburse (or cause disbursement) to the referring employee/user and/or third party (e.g., the entity affiliated with the application 11), the calculated amounts owning, such as but not limited to, by way electronic funds transfer, direct deposit, pre-loaded gift card, cryptocurrency, electronic check generation, combinations thereof, or the like. In this regard, the system 10 may comprise one or more automated funds transfer modules configured to provide for such electronic funds transfer electronically and automatically to and/or between financial institution(s) and related systems associated with the accounts of the employer, referral employee, and/or any third party involved (e.g., application 11 affiliated entity, third party recruiter, etc.).

In at least FIG. 9, user (e.g., employee user, candidate user, administrator user, and employer user) may also refer to affiliated devices (e.g., computers, servers, smartphones, tablets, combinations thereof, or the like), and/or financial institutions and/or accounts and related systems (e.g., for electronic funds transfer). These elements are not shown separately for simplicity.

System software may be implemented using MATLAB, JAVA, CGI script, Python, some combination thereof, or the like. System software may be stored on an electronic storage medium, and may be executed with the cooperation of a controller and memory. Computing devices, preferably adapted to run programming code and implement various instructions and/or functions of the software, may include by way of example and not limitation, processors, microprocessors, microcontrollers, embedded processors, DSP, some combination thereof, or the like. It will be apparent to one of ordinary skill in the art that any number of different computing and/or display devices may be employed without departing from the scope of the present invention.

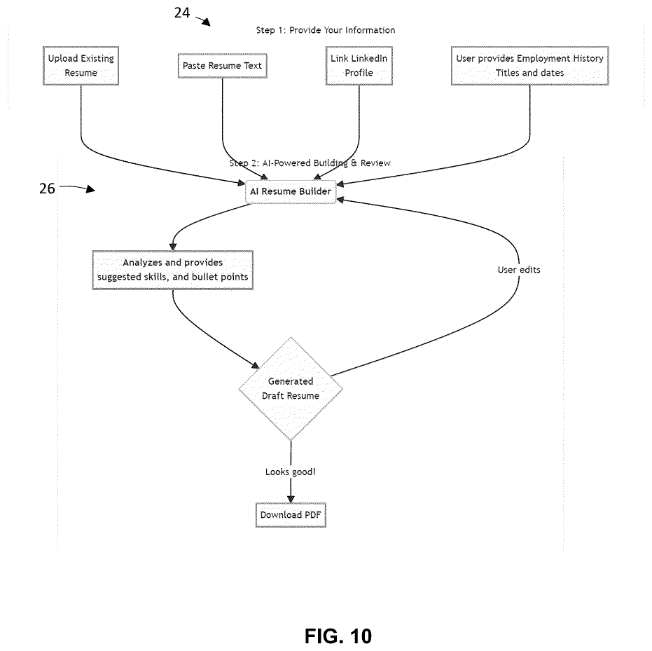

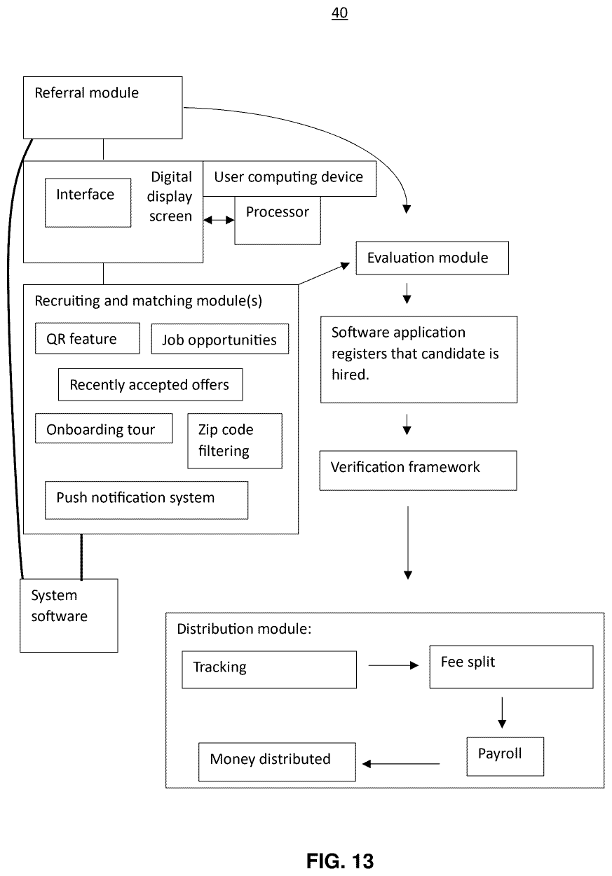

Referring now to FIGS. 10-12, exemplary logic for preferred workflows of the present invention are shown. Referring to FIG. 13, an exemplary system 40 capable of implementing one or more of the workflows of FIGS. 10-12 is shown. The system 40 may include at least one processor capable of executing software instructions for one or more software modules permitting the one or more workflows. The system 40 may include a user device, which may integrate the processor or be separate from the processor. The user computing device and/or processor may include and/or be linked to a digital display screen. The digital display screen may allow a user to interact with a user interface, which may be displayed at the digital display screen. The present invention is not limited to any particular type or number of processors, computing devices and/or display screens.

System 40 software may provide one or more modules capable of assisting a user with applying for a job, recruiting candidates for a job, finding job opportunities, filtering out job opportunities, filtering out applicants, providing alerts to users, referring candidates, evaluating applicants, tracking when applicants are hired, tracking employment, distributing money to participants, some combination thereof, or the like. System 40 software may include one or more software modules, such as, for example, a referral module, recruiting module, matching module, evaluation module, verification framework, distribution module, etc. A user may interact with the one or more modules by way of the user interface(s).

System software may permit a user to access one or more system software modules (e.g., a recruiting and/or matching module) by way of a QR code. For example, a user may scan a system QR code to access a system application feature (e.g., displaying all open job opportunities in the system). A system QR code may permit a user to download system software to the user computing device. One or more software modules of the system 40 (e.g., the recruiting and/or matching module(s)) may cause the digital display screen to display all open job opportunities, trending job opportunities, other available job opportunities, recently accepted offers, some combination thereof, or the like (e.g., to promote user engagement and activity with the system 40). The software module(s) may cause user selectable links to job opportunities, recently accepted job offers, tutorial information, filtering options, notification options, some combination thereof, or the like to be displayed at the user interface.

The software module(s) may cause (e.g., after a QR code is scanned, system log in information is entered by way of the user interface, some combination thereof, or the like) an onboarding tour (e.g., a video tutorial, such as an interactive video tutorial) to be displayed at the user interface. The onboarding tour may provide the user with a step-by-step guide on how to participate in one or more processes of the system 40. For example, the onboarding tour may provide the user with instructions on how to perform a system job application process (e.g., from start to finish).

System filtering options may include a zip code-based match filtering option. For example, a user may direct the system 40 to only display job opportunities based on an entered zip code (e.g., only display job opportunities within 50 miles of the job seeker). Alternatively, or additionally, a user may direct the system 40 to only display fully remote jobs. Any number of methods for filtering job opportunities listed at the user interface may be employed without departing from the scope of the present invention. The system 40 may also include a notification system. For example, system software may cause push notifications to be sent to a user computing device as the application process (and/or another process relevant to the system) progresses. As a specific, non-limiting example, a user may receive an alert when an application is received by a potential employer, when a referral is made, when an employment offer is made, and the like.

Referring now to FIG. 10, an exemplary AI resume builder workflow of the present invention is shown. The workflow may include an information input module 24 and a resume builder and review module 26. The user may interact with user configurable aspects of the modules 24, 26 by way of the user interface. The information input module 24 may include an option to upload an existing resume, an option to past text from a resume, an option to link one's LinkedIn profile to the system, and/or an option to provide employment history titles and dates to the system. The resume builder and review module 26 may include an option for the user to submit a resume and/or other information submitted to the first module 24 to AI, an option to receive AI analysis and suggestions (e.g., via bullet points) regarding user skills and/or strengths that may be included in a resume, an option for the user to generate a draft resume using AI, an option for the user to make edits to an AI-built resume, and/or an option for the user to download a resume (e.g., in PDF form), such as when the resume has been finalized. Referring to FIGS. 10 and 13, a finalized resume may be submitted to one or more employers by way of a recruiting and/or matching module.

Using the modules 24, 26 illustrated in FIG. 10, a user may benefit from an intelligent resume building system. The system 40 may implement LLM technology such as Open AI technology (e.g., GPT 4.1) to perform the AI functions of module 26, though the system 40 is not limited to a particular type of AI technology. The first module 24 may also take dates of employment, employer history, job title history, and the like as input from the user. After input from the first module 24 is communicated, system 40 code may create a custom prompt for the second module 26 to generate analysis and suggestions (e.g., via bullet point list) regarding user skills and/or strengths that may be included in a resume. Subject matter from a bullet point list may be manually selected and inserted into a resume, and/or automatically selected and inserted into a resume.

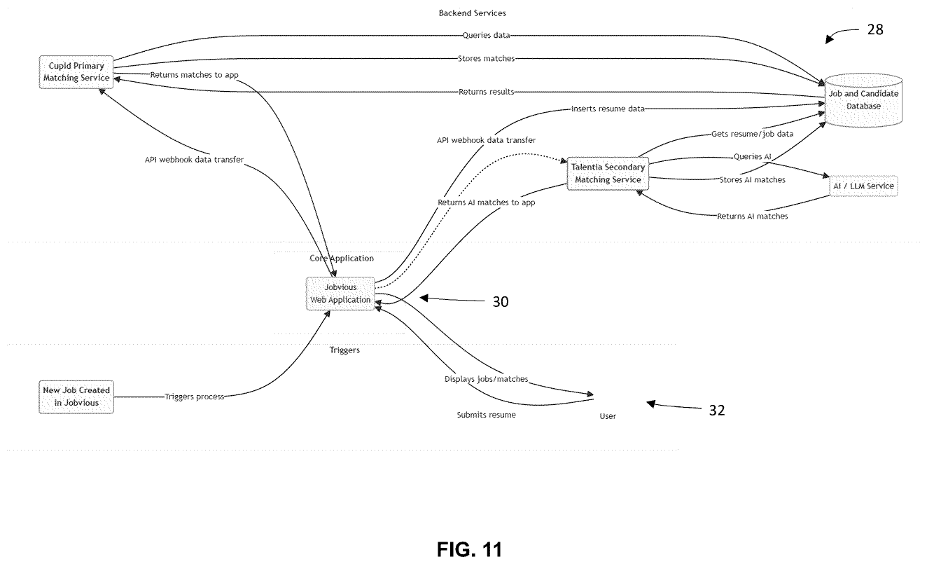

Referring to FIG. 11, an exemplary unified recruiting system workflow of the present invention is shown. The workflow may include backend services 28, a core application 30, and triggers 32. A Primary Matching Service (“Cupid”) may, using AI trained on historical data, utilize job description data points, hiring manager preferences, and resume datapoints to identify potential job matches for a user. The historical data may comprise hiring data from the last several years (e.g., last five years). The hiring data may include success and failure metrics. The historical data may include actual resume data, and the results of what happened with job applicants (e.g., a requested interview may be considered a success, and a rejection of an application may be considered a failure).

The Cupid Primary Matching Service may be in communication with a job and candidate database and core application 30 (maintained by a web application) to query data, store matches, and return results to a user regarding job opportunities. The Cupid Primary Matching Service may analyze a variety of datapoints within a resume, including, e.g., skills, skill level, years of experience, job titles, education level, tenure, industry, some combination thereof, or the like. The system may be configured to implement Cupid to parse job descriptions of open positions, and/or create an ideal profile. An ideal profile may include, for example, required skills, preferred skills, education level, and/or compensation for a particular job. The system may be configured to implement Cupid to compare one or more candidates to all open job positions, and calculate a job and candidate match score for each position, for each candidate. The system may be configured to communicate to a web application job and candidate match scores above a certain threshold (e.g., 75 out of 100) for recommendation to the user (e.g., job applicant, employer). In exemplary embodiments, without limitation, candidates reaching the threshold may be sorted and contacted in order of their score (e.g., highest to lowest still above the threshold).

The system may be configured to evaluate and compare the job candidate's work history, job skills, some combination thereof, or the like with the job descriptions of various jobs. The comparison may include evaluating various categories such as evaluating whether the candidate's working experience, skills, education, some combination thereof, or the like meets the job description's requirements and/or preferences. There may be separate categories for requirements versus preferences. A weight may be assigned to each category. The weight may vary based on information in the job description, and/or quality of the job description. The weight may be assigned by the user, automatically assigned by the system, some combination thereof, or the like. A parsing system may evaluate the candidate's skills by extracting the candidate's skills, experience and education from a resume. A proficiency score may be provided based on this extraction. The aforementioned evaluations, comparisons, and/or extractions may be quantified and applied to calculate the match score for each candidate, for each job.

The backend services may also include a Secondary Matching Service (“Talentia”), which may be in communication with a web application maintaining a core application 30, and may obtain resume/job data (e.g., from a job and candidate database), query AI, store AI matches, and return AI matches. Talentia may include an LLM (e.g., GPT 4.1 by Open AI). The system may be configured to implement Talentia to match candidates to job openings. A match may be determined by sending the raw text of a job description and resume to an LLM with a custom prompt to generate a score, along with a summary of how the score is calculated.

A job and candidate match score above a certain threshold (e.g., 75 out of 100) may be sent to the web application for recommendation to the user (e.g., job applicant, employer). The prompt may cause communication of important data points from both the candidate (e.g., the candidate resume and other candidate input) and the employer (e.g., the employer's job description). This may allow the system to calculate multiple match scores (e.g., one based on years of experience, one based on skillset, one based on education, one based on industry experience, and the like), and combine them into an overall match score, such as by summing, weighted average, combinations thereof, or the like. When new jobs are added to the system, system triggers 32 may cause said jobs to be compared with the core application 30. Talentia may identify matches missed by the primary matching system using context and a custom skill synonym library. A participant match to an open position may be required for a user (e.g., an employee) to make a referral of a candidate (e.g., to an employer). In this particular embodiment, the match may occur through Cupid, Talentia, or both (e.g., with a score of 75 or higher out of 100 achieved). Job matches may be displayed to the user at a user interface.

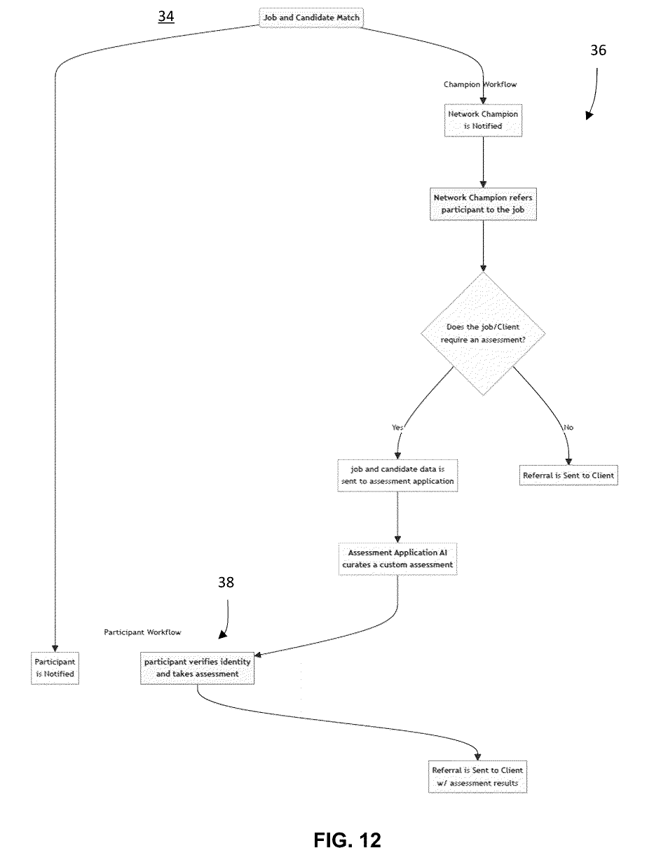

Referring to FIG. 12, an exemplary match and referral workflow 34 of the present invention is shown. The workflow 34 may include a champion workflow 36 and a participant workflow 38. In exemplary embodiments, without limitation, when a candidate is identified for an open position, the champion workflow 36 may include electronically notifying an individual employed by the employer associated with the open job position and electronically affiliated with the candidate, to make the referral (the “champion”). Assuming the referral is made, the champion becomes the referring individual, such as for receiving the ongoing compensation. The electronic affiliation information may be determined based on user electronic connections made using the system, such as via their respective devices, interfaces, and known social media affiliation techniques. The assessment portion of the champion workflow 36 is optional. The participant workflow 34 may include direct notification to the candidate, such as where a champion cannot be identified, declines to make the referral, or fails to make a referral within a predetermined period of time.

The workflow 34 may be implemented by a system referral software module, which may be integrated with an applicant tracking system (“ATS” or “JobDiva”).

Referring to FIGS. 12-13, the system 40 may cause a workflow (e.g., from an employer user) to be integrated into the ATS (e.g., for job process tracking, timekeeping, and the like). The integration may be facilitated through a two-way API, which may enable data to be both read from and written to the ATS. System workflow tracking may allow for the entire lifecycle of the candidate's application process (e.g., beginning with the initial submission) to be monitored. System workflow tracking may include monitoring important developments in the application process, such as, for example, interview requests, employer assessments, employment offers, and rejections. Optionally, such ATS data may be utilized to automatically update the user/profile information, such as for social media and matching purposes. For example, current employment information, credentials, work experience, and the like may be automatically updated by the ATS information and used to provide further, updated matching accordingly over time.

Users may make referral of candidates via the champion workflow 36. In exemplary embodiments, without limitation, as discussed herein, the system 10 may be configured to identify champions, who may be electronically associated individuals with an identified candidate for a job opening.

Where an assessment is required by an employer user, job and candidate data may be sent to an assessment application module to allow a participant to verify one's identity, and take an assessment. A referral may be sent to an employer user with the results of the assessment. The assessment application may include an assessment application tool, such as but not necessarily limited to, those available from VeriKlick Inc. of Newark, New Jersey (https://veriklick.com).

Matches may be displayed to the user making the referral (“network champion” or “referrer”) as they occur. Furthermore, a candidate may be notified of matches as they occur. Once a match is displayed to the network champion, the participant may be referred to the job. At each stage of the process, participants and network champions may be notified of the application progress (e.g., interview request submitted, assessment requested, offer sent, rejection sent, employment commenced, employment terminated) being tracked by the system. Notifications may be sent to user devices in real time. This data may be provided by way of the ATS and tracked by the system 10, such as for determining if/when referral compensation is due.

Referring specifically to FIG. 13, the system 40 may include a distribution module configured to track employment, and split and distribute a fee to a user based on tracked employment and a referral made by the user. Fee distribution may be implemented according to a passive income module. The passive income module may be integrated with a timekeeping system. This may allow automatic payout tracking for both a participant (job applicant) and network champion (employee making a job referral). An ATS may be utilized to track employment and timekeeping of the participant and network champion. The employment and timekeeping data may be communicated through API to the system 40 by way of the ATS.

Payout tracking may be calculated by the system based on pay rate of the candidate. The number of hours worked by a participant may directly influence the payout amount for the network champion. For example, during the duration of a candidate's assignment, a network champion may receive 10% of the candidate's hourly pay rate for every hour the candidate works. Thus, tracking timekeeping may be required to calculate a payout for the network champion. Timekeeping integration may also allow for multiple pay rates (e.g., overtime, double time, special projects, pay increases, and the like) for the same candidate over time to be considered. The foregoing are provided by way of example, and without limitation.

Employment and timekeeping data may be entered into the ATS from multiple sources. One source may include, for example, a contractor entering time into a Vendor Management System (VMS). In this particular example, a supervisor may have the ability to approve or reject a timecard. A payroll team may manually pull a report of time in each VMS, and import the time into the ATS. Another source may include, for example, time being sent via email from the employer to a payroll team, which may manually enter the time into the ATS. Yet another source may include the ATS' own timekeeping system. ATS accounts may be set up for contractors to enter time and hiring managers to approve time.

The ATS and/or API may be configured to, for example, provide reformatting of data from various VMS′, which may each include one or more specific formats, into a common format. This may allow information in otherwise disparate, normally non-communicative systems and/or formats to be commonly gathered and reviewed, such as to facilitate ongoing referral payments.

Each network champion may be attributed a fee split based on the employment and timekeeping data. The fee split amount may be communicated (e.g., via an export from the system 40) to a payroll system for the fee split to be reflected in a network champion's paycheck or other form of disbursement. The payroll system may be integrated with the matching, referral and fee distribution system 40 of FIG. 13. The system 40 may be configured to track relationships between participants and network champions. The system may be configured to generate an employment record in the ATS. The fee split may be a percentage of the referred employee's income (e.g., a percentage of the referred employee's hourly pay) distributed over time increments, though other calculations may be utilized (e.g., flat fee, amount per time increment worked, combinations thereof, or the like). The system 40 may be configured to directly distribute the fee split to the network champion's account. The fee distribution may be made to a referrer's bank account by way of an electronic funds transfer (e.g., to a stored routing and account number).

In exemplary embodiments, the system 10 may include one or more servers. The servers preferably host the software application 11 which may provide matching, referral tracking, and fee calculation on the backend, along with the social media module/platform, which may be user facing. The server(s) may be in electronic communication with user devices, such as associated with workers, representatives of hiring entities, recruiters, combinations thereof, or the like.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

Certain operations described herein may be performed by one or more electronic devices. Each electronic device may comprise one or more processors, electronic storage devices, executable software instructions, and the like configured to perform the operations described herein. The electronic devices may be general purpose computers or specialized computing device. The electronic devices may comprise personal computers, smartphone, tablets, databases, servers, or the like. The electronic connections and transmissions described herein may be accomplished by wired or wireless means. The computerized hardware, software, components, systems, steps, methods, and/or processes described herein may serve to improve the speed of the computerized hardware, software, systems, steps, methods, and/or processes described herein.

What is claimed is:

1. A system facilitating worker employer referral matching and ongoing referral payments, the system comprising:
one or more servers in electronic communication with user devices, and hosting a backend software application and user facing social media platform, said one or more servers comprising at least one database comprising identity data and resume information for individuals, job criteria associated with job identifiers, and electronic associations between users from the user facing social media platform;
said one or more servers further comprising software instructions that, when executed, configure one or more processors to, electronically and automatically:
receive data from a first subset of the user devices indicating the identity data and resume information for job candidates;
extract, from the received data from the first subset of the user devices, said resume information and said identifying data for the job candidates for storage at the one or more databases;
receive, from a second subset of the user devices, job descriptions;
extract, from the received data from the second subset of the user devices, the job descriptions for storage at the one or more databases, each with a respective, assigned one of the job identifiers;
compare said resume information for the job candidates to said job descriptions;
determine match scores for the job candidates based on the comparison;
for each of the job descriptions, determine a highest scored one of the matched job candidates where the match score is also above a predetermined threshold (“matched candidate”);
display information regarding the matched candidate at an electronic display screen of a respective one of the user devices associated with a referring individual; and
receive confirmation of employment for the matched candidate, and subsequently and in response, calculate a fee for the referring individual and cause electronic disbursement of the fee to an account provided at, and retrieved from, the database in association with the identifying information for the referring individual.

2. The system of claim 1, wherein the one or more servers further comprise software instructions that, when executed, configure the one or more processors to electronically and automatically track employment status of at least the matched candidate periodically over time, and cause the fee to be selectively distributed to the referring individual periodically over time to the account based on the employment status of the matched candidate.

3. The system of claim 2, wherein the one or more servers host an applicant tracking system (“ATS”) for providing the employment status of the matched candidate.

4. The system of claim 3, wherein the fee is calculated as a predetermined percentage of the job candidate's earnings.

5. The system of claim 4, wherein the fee is distributed in the form of an electronic funds transfer.

6. The system of claim 3, wherein:
the ATS is in electronic communication with vendor management systems (“VMS”) associated with employers.

7. The system of claim 6, further comprising:
an application program interface (“API”) hosted at the one or more servers and configured to collect and reform employment status and earnings information from the VMS for processing by the ATS.

8. The system of claim 1, wherein the one or more servers further comprise a resume builder and review module configured to extract data from a preexisting resume electronically uploaded from one of the first subset of user devices, receive manually input experience information from the one of the first subset of user devices, and apply an LLM trained on job resumes to generate a new, optimized resume based on the extracted data and manually input experience information.

9. The system of claim 1, wherein the one or more servers further comprise software instructions that, when executed, configure the one or more processors to:
for each of the matched candidates, identify one of the users (“champions”) indicated, based on the resume information associated with the user at the database, as being employed at a respective hiring company for a respective one of the job descriptions and indicated as electronically associated with the matched candidate at the database from the social media platform, and subsequently cause a notification to be sent to a respective one of the first subset of user devices associated with the champion indicating that the job candidate is identified for an open position.

10. The system of claim 9, wherein the one or more servers further comprise software instructions that, when executed, configure the one or more processors to:
generate, at the user device associated with the champion, a customizable, template referral invitation for sending to the matched candidate;
in response to champion customization or approval of the template referral invitation, cause the referral invitation to be sent to the user device associated with the matched candidate; and
cause information about the matched candidate to be communicated to a respective one of the second subset of the user devices associated with the job description.

11. The system of claim 10, wherein the one or more severs further comprise software instructions that, when executed, configure the one or more processors to generate a QR code as part of the template referral invitation configured to, when scanned by a camera of a user device associated with the user, cause one or more software interfaces of the system to be displayed at the electronic display screen.

12. The system of claim 11, wherein the one or more severs further comprise software instructions that, when executed, configure the one or more processors to retrieve and display a stored video tutorial to the job candidate after, in response to, receiving indication that the job candidate scanned the QR code.

13. The system of claim 1, wherein the one or more severs further comprise software instructions that, when executed, configure the one or more processors to receive zip code information and filter potential job matches based on the zip code information.

14. The system of claim 1, wherein the one or more servers further comprise software instructions that, when executed, configure the one or more processors to identify, using a primary matching service, one or more job matches for at least one of the job candidates based on data received from the first and second subsets.

15. The system of claim 1, wherein the one or more servers further comprise software instructions that, when executed, configure the one or more processors to identify, using a primary and secondary matching service, one or more job matches for at least one of the job candidates based on data received from the first and second subsets.

16. A method facilitating worker employer referral matching and ongoing referral payments, the method comprising:
providing one or more servers in electronic communication with user devices, and hosting a backend software application and user facing social media platform, said one or more servers comprising at least one database comprising identity data and resume information for individuals, job criteria associated with job identifiers, and electronic associations between users from the user facing social media platform;
configuring said one or more servers with software instructions that, when executed, cause one or more processors to, electronically and automatically:
receive data from a first subset of the user devices indicating the identity data and resume information for job candidates;
extract, from the received data from the first subset of the user devices, said resume information and said identifying data for the job candidates for storage at the one or more databases;
receive, from a second subset of the user devices, job descriptions;
extract, from the received data from the second subset of the user devices, the job descriptions for storage at the one or more databases, each with a respective, assigned one of the job identifiers;
compare said resume information for the job candidates to said job descriptions;
determine match scores for the job candidates based on the comparison;
for each of the job descriptions, determine a highest scored one of the matched job candidates where the match score is also above a predetermined threshold (“matched candidate”);
display information regarding the matched candidate at an electronic display screen of a respective one of the user devices associated with a referring individual; and
receive confirmation of employment for the matched candidate, and subsequently and in response, calculate a fee for the referring individual and cause electronic disbursement of the fee to an account provided at, and retrieved from, the database in association with the identifying information for the referring individual.

17. A system facilitating worker employer referral matching and ongoing referral payments, the system comprising:
one or more servers in electronic communication with user devices, and hosting a backend software application and user facing social media platform, said one or more servers comprising at least one database comprising identity data and resume information for individuals, job criteria associated with job identifiers, and electronic associations between users from the user facing social media platform;
said one or more servers further comprising software instructions that, when executed, configure one or more processors to, electronically and automatically:
receive data from a first subset of the user devices indicating the identity data and resume information for job candidates;
extract, from the received data from the first subset of the user devices, said resume information and said identifying data for the job candidates for storage at the one or more databases;
receive, from a second subset of the user devices, job descriptions;
extract, from the received data from the second subset of the user devices, the job descriptions for storage at the one or more databases, each with a respective, assigned one of the job identifiers;
compare said resume information for the job candidates to said job descriptions;
determine match scores for the job candidates based on the comparison;
for each of the job descriptions, determine a highest scored one of the matched job candidates where the match score is also above a predetermined threshold (“matched candidate”);
display information regarding the matched candidate at an electronic display screen of a respective one of the user devices associated with a referring individual; and
receive confirmation of employment for the matched candidate, and subsequently and in response, calculate a fee for the referring individual and cause electronic disbursement of the fee to an account provided at, and retrieved from, the database in association with the identifying information for the referring individual;
wherein the one or more servers further comprise software instructions that, when executed, configure the one or more processors to:
for each of the matched candidates, identify one of the users (“champions”) indicated, based on the resume information associated with the user at the database, as being employed at a respective hiring company for a respective one of the job descriptions and indicated as electronically associated with the matched candidate at the database from the social media platform, and subsequently causes a notification to be sent to a respective one of the first subset of user devices associated with the champion indicating that the job candidate is identified for an open position; and
generate, at the user device associated with the champion, a customizable, template referral invitation for sending to the matched candidate;
in response to champion customization or approval of the template referral invitation, cause the referral invitation to be sent to the user device associated with the matched candidate; and
cause information about the matched candidate to be communicated to a respective one of the second subset of the user devices associated with the job description.
